(19) United States
(12) Patent Application Publication
(10) Pub. No.: US 2025/0196937 A1
(43) Pub. Date: Jun. 19, 2025

(54) Automotive body made from reinforced structurally insulated panels and process of manufacture

(71) Applicant: Frederic Ruiz-Ramon, Fairfax, VA (US)

(72) Inventor: Frederic Ruiz-Ramon, Fairfax, VA (US)

(21) Appl. No.: 18/846,200

(22) PCT Filed: Mar. 15, 2023
(86) PCT No.: PCT/US23/15323

§ 371 Date: Sep. 11, 2024

Related U.S. Application Data
(60) Provisional application No. 63/320,521, filed on Mar. 16, 2022.

(51) Int. Cl. B62D 29/04; B32B 3/12; B32B 5/20; B32B 7/12; B32B 27/06; B32B 27/12; B32B 27/32; B32B 27/36; B60R 13/08; B62D 29/00; B62D 65/02

(52) U.S. Cl. CPC B62D 29/043; B32B 3/12; B32B 5/20; B32B 7/12; B32B 27/065; B32B 27/12; B32B 27/32; B32B 27/365; B60R 13/08; B62D 29/005; B62D 65/02; B32B 2255/10; B32B 2255/26; B32B 2266/0228; B32B 2266/08; B32B 2307/304; B32B 2307/3065; B32B 2307/7376; B32B 2605/00

(57) ABSTRACT

A structurally insulated body panel (SIP), a body panel made of SIPs and metal tubing skeleton, a vehicle body made of multiple SIPs, and a related process of manufacture.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

### Field of the Invention

The present invention is an automotive body made from reinforced structurally insulated panels (SIP) and a related process of manufacture.

### Background of the Invention

The list of commonly used materials for the manufacture of vehicle bodies for personal and commercial use is quite limited, comprised primarily of steel, aluminum, fiberglass and plastic. High performance cars may have carbon fiber bodies which are extremely expensive. There have been vehicles made with wooden chassis, complete wooden bodies, or bodies with significant wooden elements. Of these materials, steel remains the go-to material for most automobiles and trucks for construction of chassis, suspension components, door beams, roofs and body panels. Steel is preferred because it provides a high level of strength and rigidity, and is easy to form into interlocking shapes using tools like stamping presses. Steel is also heavy, so the use of aluminum in components like hoods, trunks and doors has also increased over time.

Steel also has drawbacks in the context of auto body manufacturing. The weight of the average midsize sedan is now 3,300 pounds, while the weight of the average pickup truck is over 4,000 pounds. Of those weights, approximately 2,000 pounds is steel, which at current prices costs about $5,000. Further, the use of steel panels on vehicles means that contact between the vehicle and other objects leads to scratches, dings and dents that are difficult and expensive to repair. Steel also rusts and heats up in the sun.

What is needed is a lower-cost alternative material for vehicle body construction that offers the positive characteristics of steel without the drawbacks.

### BRIEF DESCRIPTION OF THE INVENTION

In a preferred embodiment, a structurally insulated panel (SIP), comprising: outer layers comprising plastic honeycomb formed with an open cell configuration and a layer of resin mixed with fiberglass adhered to each side, such outer layers surrounding and adhered to a middle layer of extruded plastic insulation board.

In another preferred embodiment, the SIP as described herein, wherein the outer layers are made of polycarbonate (PC), polypropylene (PP) or another plastic with similar characteristics, an outer coating of fiberglass or a similar waterproof substance, and the middle layer is made of polystyrene (XPS) or another plastic with similar characteristics.

In another preferred embodiment, the SIP as described herein, wherein the XPS of the middle layer is closed-cell extruded XPS with a minimum compressive strength of 25 psi.

In another preferred embodiment, the SIP as described herein, wherein the extruded plastic insulation board of the middle layer is approximately 1″ thick.

In another preferred embodiment, the SIP as described herein, wherein the outer layers are adhered to both sides of the middle layer with a spray adhesive from the group consisting of epoxies, urethanes, viscoelastic, foam, gap-filling adhesives (e.g., foam tapes), or similar known adhesives.

In another preferred embodiment, the vehicle body comprising multiple SIPs as described herein, further comprising one or more interlocking tubes made of aluminum, steel or structural fiberglass, arranged as a frame by displacing foam within the middle SIP layer.

In another preferred embodiment, the vehicle body comprising multiple SIPs as described herein, wherein the interlocking tubes interconnect to form the full body using connection pieces.

In another preferred embodiment, the vehicle body comprising multiple SIPs as described herein, wherein the means of interconnection is with known one or more fastening means such as bolts, rivets, adhesives or snap-fit.

In another preferred embodiment, the vehicle body comprising multiple SIPs as described herein, wherein the assembled vehicle body is sprayed with a polyurea coating containing fireproof additives.

In another preferred embodiment, a process of manufacturing a vehicle body, consisting of:
1. forming each of the three layers of an SIP of claim 1,
2. coating each of the outer layers of the SIP with a fiberglass-containing resin,
3. arranging a metal tube skeleton within each SIP according to claim 6,
4. connecting the metal tubing of multiple body panels such that the panels together form a vehicle body; and
5. completely cover the inside and outside of the vehicle body with polyurea coating containing fireproof additives.

### BRIEF DESCRIPTION OF THE DRAWINGS

FIG. 1 shows an exploded view of one SIP and a second fully assembled SIP, each with tubing and connection pieces.

FIG. 2 is a line drawing evidencing a view of a full connected set of tubing for a vehicle body.

FIG. 3 is a line drawing evidencing an embodiment of a tubing connector.

FIG. 4 is a line drawing evidencing an exploded and assembled cross-section of a SIP.

FIGS. 5 and 6 are each line drawings evidencing a vehicle comprised of SIPs.

### DETAILED DESCRIPTION OF THE INVENTION

The invention is a motorized vehicle body and related method of manufacture. The material used for constructing the body of an automobile consists of structurally insulated panels (SIP) composed of: (1) an outer layer of polypropylene or another plastic with similar properties in a honeycomb pattern formed with an open cell configuration with a face layer of resin mixed with fiberglass adhered to each side; (2) a middle layer of insulation board made of extruded polystyrene (XPS) or a plastic with similar properties; and (3) an inner layer of the same plastic honeycomb of the outer layer, also coated with a layer of resin mixed with fiberglass on each side.

In a preferred embodiment, the plastic honeycomb, preferably polypropylene, or a plastic with similar properties. Honeycomb patterned sheets of plastic have properties that dampen vibration, thus providing a smoother and quieter ride for passengers inside a vehicle. The honeycomb pattern also provides a level of flexibility that allows the sheets to deform and return to shape, thus providing a level of toughness, resiliency and non-corrosiveness beyond that of typical metallic vehicle body panels. The honeycomb panel will have the the following specifications range: compressive strength between 228 psi and 275 psi, tensile strength of 119 psi to 130 psi, a shear strength of 65 psi to 85 psi, thermal conductivity of k=0.03, water absorption in 24 hours of 0.10%, dimensional thermal stability of −40° F. to 230° F., density of 4.6 lb/ft³ and 5.0 lb/ft³ and sound attenuation greater than 22 db.

In a more preferred embodiment, the honeycomb cell walls are fused into a non-woven polyester scrim, which provides an affinity for any resin or adhesive and thus gives the panels a high level of bond and peel strength.

The application of fiberglass is a known process of spraying or otherwise applying, for example, a layer of resin, a sheet of fiberglass, and another layer of resin. In some cases, fiberglass is applied as a gel or a weave.

Preferably, the thickness range of such honeycomb layer is in the range of 6 mm to 100+ mm, with a preferred thickness of 8 mm. In a more preferred embodiment, the SIP body panels are created in large dimensions, up to 2 m×3 m, enabling trimming to yield a full side, top or floor panel without seams. Thus, with only four interlocking panels, the entire car body can be assembled.

In another preferred embodiment, the insulation board of the middle layer is especially rigid and thus able to withstand significant weight or trauma. In this embodiment, 1′R5 rated extruded plastic insulation board is preferred, with extruded polystyrene (foam) or similar material being used. In a preferred embodiment, the board is 0.5-2″ thick, or more preferably 1″ thick.

Within the panels, metal tubing is placed in such a way that when panels are interconnected, the tubes connect to create roll cages and side impact resistant protection for vehicle passengers. Such tubing can be made of metals or alloys such as, without limitation, steel, aluminum, titanium, or other metals and alloys used in vehicle construction. Connection between the tubes in two or more panels may be created by fasteners such as rivets, screws or bolts, or by welding or other known processes.

In a preferred, non-limiting embodiment, the tubing is rectangular or cylindrical and steel, aluminum or fiberglass, running inside the SIP through channels cut into the central insulation board panel. In this iteration, the connector pieces are nonmetallic and squared to interlock with the tubing, using bolts, rivets, snap-fit, adhesives or other commercially available means of attachment. The tubing and connectors are embodied in 1″-3″ widths, either as squares or rectangles. Acceptable nonmetallic materials include, without limitation, any sufficiently rigid and/or durable plastic, carbon fiber, structural fiberglass FRP or similar substances. Known adhesives for application in the overlay area between the connector pieces and tubing include, without limitation, known styrofoam-adhesive coatings, 3M Spray 78 and similar applications.

The assembled body is then coated in a sprayed polyurea coating, preferably 3-6 mm in thickness, completely covering the inside and outside of the body. The polyurea coating contains additives to make the body fireproof to high temperatures and to reflect most solar energy away from the surface of the body.

Polyurea is an elastomer substance that, in its polymer form, is derived from step-growth polymerization, which involves combining a synthetic resin and isocyanate reactive materials. Thus, the reaction of an isocyanate part with a resin blend component part through the step growth process of polymerization produces polyurea. The substance provides a glossy appearance with resistance to color change or fading due to sun exposure and excellent abrasion and scratch resistance, as well as resistance to chemicals, oil and salts. It also increases the strength of the coated body made of SIP panels as described in the patent while ensuring each panel can flex as needed to typical torsional forces encountered by vehicles, especially on rough or uneven surfaces. Polyurea also aids the SIPs in dampening vibrations and noise.

Before application, the polyurea is treated with a Thermo Pro additive from NRG Super Coatings which ensures the body becomes noncombustible and flame/fire resistant to class a, b, c, d fires and fireproof to ASTM E-285 standards (5000-6000 degrees farenheit (F) Oxycetalyne torch test). The resulting polyurea treatment also allows our body's solar reflectivity to 0.891-0.998 increasing the insulative properties of the body beyond an initial R5+ rating is inherent in the Polystyrene XPS extruded insulation board middle layer of the SIP panel. For this application, an “R rating” is a measure of insulation performance, wherein a R value of 1 indicates ° F.·ft2·hr/Btu per each inch of thickness, with a corresponding increase in performance for increasing numerical value.

This product is also biologically and environmentally safe. All of the products in the car body (polycarbonate, polystyrene xps, fiberglass resin/fiberglass, steel/aluminum/or FRP fiberglass tubes, and the polyurea) are recyclable.

The unique combination of elements (outer layers, internal insulation, reinforcing structures, and coating with additives) results in an extremely strong, light, quiet and inexpensive material that is highly resistant to high temperature fire. The resulting vehicle body does not heat interior spaces due to solar energy, is resistant to kinetic energy shocks, is not susceptible to corrosion, is easy to cut with simple low energy usage machinery and is very inexpensive to produce compared to typical metallic and fiberglass vehicle bodies. Finally, the material used is all recyclable.

The result is a car body that is highly resistant to damage from crashes, does not rust, does not burn, transmits very little external noise and thus maintains a cool and quiet interior space. This body can be produced at a fraction of the cost of a traditional steel, steel and other metals, or carbon fiber or similar materials car body.

The production process of the body is generally much more environmentally friendly as compared to traditional automotive body production methods. For example, there is no requirement for large amounts of chemicals or paints to provide anticorrosion and other protective properties, while power requirements for assembly are much lower, meaning lower emissions.

### DETAILED DESCRIPTION OF THE DRAWINGS

FIG. 1 shows a cross section view of a side panel 12 showing two honeycomb panels 21A surrounding an extruded insulation board 24 center, and a second insulation board 24, with tubing member 22 located within the foam construction of the insulation board to illustrate the means of connecting panels using tubing frame 22 and connectors 23.

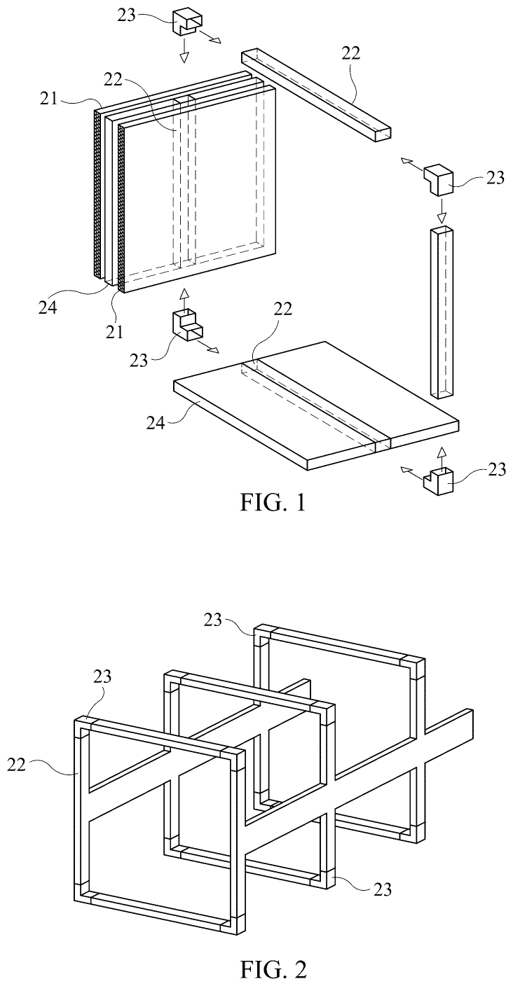

FIG. 2 shows a plurality of tubing members 22, embodied with a rectangular shape, interconnected with tubing connectors 23 to form a frame for a vehicle.

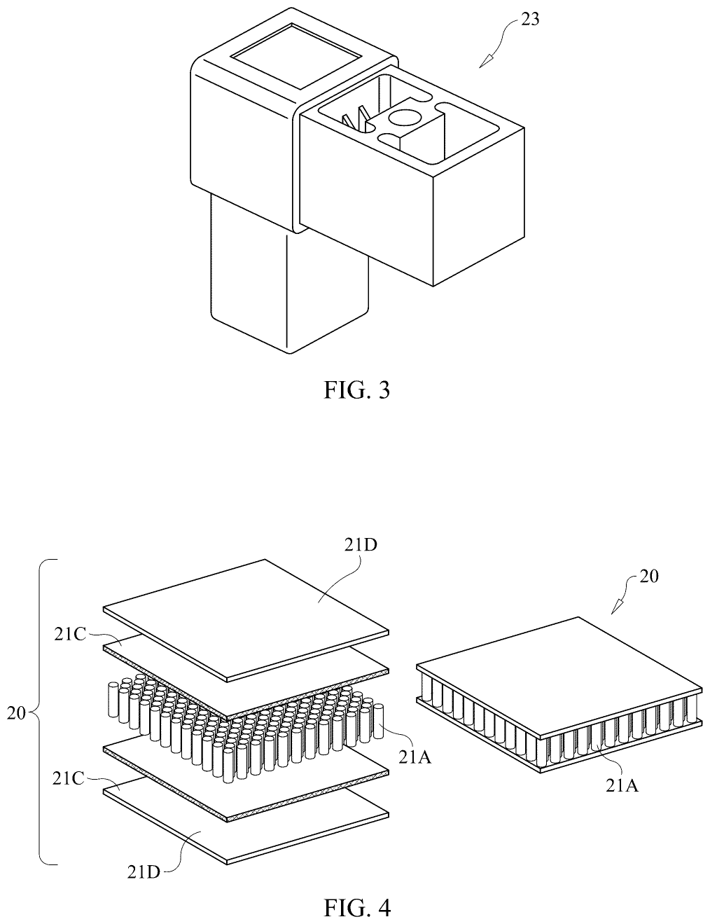

FIG. 3 shows a closeup view of a tubing connector 23, which can be made from hard plastic, metal or a similar material. Depending on the nature of the tubular members to be connected, the tubing connector may be embodied as L-shaped, straight, T-shaped or configured to attach more than two members.

FIG. 4 shows an exploded view of a SIP outer layer 21 next to an assembled SIP outer layer 21, each with two face sheet 21D outer layers, and 21C adhesive attaching the outer layers to an inner layer of honeycomb panel 21A.

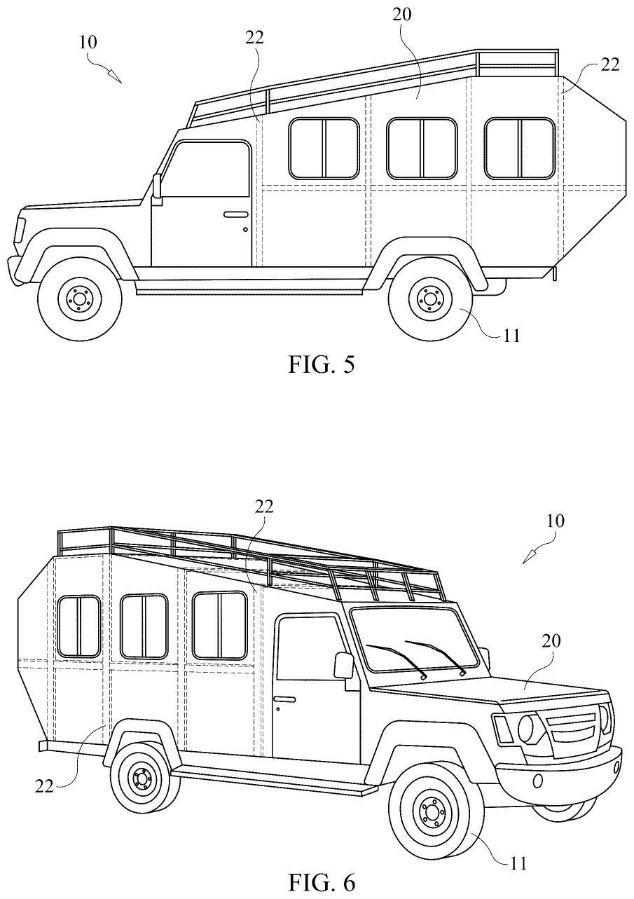

FIGS. 5 and 6 each show a vehicle 10 with wheels 11 and a body side panels 12 of the SIP construction disclosed herein, wherein tubing members 22 within the panels are shown in broken lines.

### INDEX OF PARTS

10 Vehicle
11 Wheel
12 Side Panel
20 SIP panel
21 SIP panel outer layer
21A Honeycomb panel
21C Adhesive
21D Face sheet
22 Tubing member
23 Tubing connectors
24 Extruded insulation board

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

I claim:

1. A structurally insulated panel (SIP), comprising: outer layers comprising plastic honeycomb formed with an open cell configuration and a layer of resin mixed with fiberglass adhered to each side, such outer layers surrounding and adhered to a middle layer of extruded plastic insulation board.

2. The SIP of claim 1, wherein the outer layers are made of polycarbonate (PC), polypropylene (PP) or another plastic with similar characteristics, an outer coating of fiberglass or a similar waterproof substance, and the middle layer is made of polystyrene (XPS) or another plastic with similar characteristics.

3. The SIP of claim 2, wherein the XPS of the middle layer is closed-cell extruded XPS with a minimum compressive strength of 25 psi.

4. The SIP of claim 1, wherein the extruded plastic insulation board of the middle layer is approximately 1″ thick.

5. The SIP of claim 1, wherein the outer layers are adhered to both sides of the middle layer with a spray adhesive from the group consisting of epoxies, urethanes, viscoelastic, foam, gap-filling adhesives (e.g., foam tapes), or similar known adhesives.

6. A vehicle body panel comprising multiple SIPs of claim 1, further comprising one or more interlocking tubes made of aluminum, steel or structural fiberglass, arranged as a frame by displacing foam within the middle layer of extruded plastic insulation board.

7. A vehicle body comprising multiple SIPs of claim 6, wherein the interlocking tubes interconnect to form the full body using connection pieces.

8. The vehicle body comprising multiple SIPs of claim 7, wherein the means of interconnection is with known one or more fastening means such as bolts, rivets, adhesives or snap-fit.

9. A vehicle body comprising multiple SIPs of claim 6, wherein the assembled vehicle body is sprayed with a polyurea coating containing fireproof additives.

10. A process of manufacturing a vehicle body, consisting of:
1. combining each of the three layers of an SIP according to claim 1,
2. coating each of the outer layers of the SIP with a fiberglass-containing resin,
3. repeating steps 1 and 2 to make a plurality of SIPs and designing the plurality of SIPs into shapes that, when combined, form a vehicle body;
3. arranging a metal tube skeleton within each SIP according to claim 6,
4. connecting the metal tubing of multiple SIPs to form the vehicle body; and
5. completely covering the inside and outside of the vehicle body with polyurea coating containing fireproof additives.
